(19) United States
(12) Patent Application Publication
(10) Pub. No.: US 2026/0064903 A1
(43) Pub. Date: Mar. 5, 2026

(54) METHOD AND SYSTEM FOR EVALUATING RELIABILITY OF BLIND MATING INTERCONNECTION OF PHASED-ARRAY ANTENNA

(71) Applicant: 38TH RESEARCH INSTITUTE, CHINA ELECTRONICS TECHNOLOGY GROUP CORPORATION, Hefei (CN)

(72) Inventors: Hongqi ZHANG, Hefei (CN); Wenjun SHENG, Hefei (CN)

(21) Appl. No.: 19/382,356

(22) Filed: Nov. 7, 2025

Related U.S. Application Data
(63) Continuation of application No. PCT/CN2024/105473, filed on Jul. 15, 2024.

(30) Foreign Application Priority Data
Jun. 4, 2024 (CN) 202410711079.2

(51) Int. Cl. G06F 30/17; G06F 111/08; G06F 119/14

(52) U.S. Cl. CPC G06F 30/17; G06F 2111/08; G06F 2119/14

(57) ABSTRACT

A method for evaluating reliability of blind mating interconnection of a phased-array antenna, in which a mathematical model of the phased-array antenna is obtained by computer aided design (CAD) to calculate a blind mating clearance tolerance for each level; a non-load-bearing structure within the CAD mathematical model is simplified to establish a finite element model; load conditions are introduced for structural deformation analysis to obtain blind mating clearance variations of blind mate connectors; blind mate clearance variations of blind mate interconnections and the blind mating clearance tolerance are summed to determine whether mechanical reliability of the phased-array antenna is unqualified; if yes, the evaluation is ended; otherwise, a total blind mating clearance variation of individual blind mating connectors caused by temperature, acceleration overload, and random vibration load is calculated to determine whether electrical reliability of the phased-array antenna is qualified.

### CROSS-REFERENCE TO RELATED APPLICATIONS

This application is a continuation of International Patent Application No. PCT/CN2024/105473, filed on Jul. 15, 2024, which claims the benefit of priority from Chinese Patent Application No. 202410711079.2, filed on Jun. 4, 2024. The content of the aforementioned application, including any intervening amendments made thereto, is incorporated herein by reference in its entirety.

### TECHNICAL FIELD

This application relates to digital design technology, and more particularly to a method and a system for evaluating reliability of blind mating interconnection of a phased-array antenna.

### BACKGROUND

A phased-array antenna, generally including an antenna array, a transceiver component, and a power divider network, has been widely used in the aerospace field, such as Earth observation, inter-satellite communication and early warning detection. A single phased-array antenna often consists of hundreds or even thousands of antenna elements, each requiring interconnection with a corresponding radio frequency (RF) channel of the transceiver component to achieve RF feeding. To meet the design requirements of the low profile, high integration and multiple connection paths of phased-array antennas in the aerospace filed, blind mating interconnections are commonly employed to replace the cable connections during the antenna structural design, which can facilitate multi-level RF or low-frequency interconnections between antenna elements and the transceiver component or between the transceiver component and the power divider network.

Phased-array antennas based on blind mating interconnection are characterized by the multiple connection levels, small size, and light and compact structure, as well as extremely strict requirements for mating clearances. Excessive structural deformation will lead to misalignment and increased mating clearances, and also cause attenuation or even disconnection of RF transmission channels of the antenna elements, thereby attenuating the overall performance of the phased-array antennas. In the aerospace field, phased-array antennas must endure harsh external loads such as extreme temperature variations and intense vibrations, raising even higher demands on the reliability of the blind mating interconnections.

Currently, for the phased-array antennas used in the aerospace field, the reliability evaluation of the blind mating interconnection primarily relies on full-system vibration tests conducted during the prototype phase, and the blind mating interconnection reliability is determined by monitoring the performance of RF signal transmission channels. If the blind mating interconnection is found to be unreliable, the structural design must be adjusted, which is both time-consuming and labor-intensive. Therefore, there is an urgent need to provide a method for evaluating the reliability of blind mating interconnection of phased-array antennas during the design phase.

### SUMMARY

In view of the above deficiencies in the prior art, the present application provides a method for evaluating reliability of blind mating interconnection of a phased-array antenna during the design phase.

To achieve the above objectives, the present disclosure provides the following technical solutions.

In a first aspect, a method for evaluating reliability of blind mating interconnection of a phased-array antenna, comprising:
(1) obtaining a mathematical model of the phased-array antenna by using computer aided design (CAD); extracting a closed dimensional chain between the plurality of blind mating connectors at individual levels and an assembly reference from the mathematical model; and calculating a blind mating clearance tolerance of each level of the multi-level blind mating interconnection structure based on a dimensional tolerance of the closed dimensional chain;
(2) simplifying a non-load-bearing structure within the CAD mathematical model to establish a finite element model of the phased-array antenna;
(3) respectively introducing a plurality of load conditions to the finite element model followed by structural deformation analysis to obtain a blind mating clearance variation of each of the plurality of blind mating connectors;
(4) calculating a sum of blind mating clearance variations of each of the plurality of blind mating connectors and the blind mating clearance tolerance to obtain a blind mating clearance extreme value; and
determining whether the blind mating clearance extreme value exceeds a threshold;
if yes, identifying mechanical reliability of the blind mating interconnection of the phased-array antenna as unqualified, and ending an evaluation process, otherwise, proceeding to step (5) phased-array antenna; and
(5) calculating a total blind mating clearance variation of each of the plurality of blind mating connectors caused by temperature, acceleration load, and random vibration load as an electrical clearance; calculating an actual value of each of electrical performance indicators of the phased-array antenna based on the electrical clearance and an insertion loss of each of the plurality of blind mating connectors; determining a difference between the actual value and a corresponding ideal value; and determining whether the difference is less than a threshold of a corresponding electrical performance indicator, if yes, identifying electrical reliability of the phased-array antenna as qualified.

In an embodiment, the tolerance comprises a worst-case tolerance.

In an embodiment, the dimensional tolerance of the closed dimensional chain comprises a part dimensional tolerance and an assembly dimensional tolerance.

In an embodiment, the plurality of load conditions comprise static analysis loads and dynamic analysis loads;
the static analysis loads comprise an assembly stress generated during an assembly process of the phased-array antenna, a temperature during a service process of the phased-array antenna, and an acceleration load endured during the service process; and
the dynamic analysis loads comprise a random vibration load during the service process, wherein the random vibration load is represented by a power spectral density, and follows a normal distribution.

In an embodiment, the step of respectively introducing a plurality of load conditions to the finite element model followed by structural deformation analysis to obtain a blind mating clearance variation of each of the plurality of blind mating connectors comprises:
introducing the static analysis loads to the finite element model followed by static structural deformation analysis to obtain the blind mating clearance variation of each of the plurality of blind mating connectors; and
introducing the dynamic analysis loads to the finite element model followed by dynamic structural deformation analysis to obtain the blind mating clearance variation of each of the plurality of blind mating connectors, wherein the dynamic structural deformation analysis is performed through steps of:
(a) performing modal analysis for the phased-array antenna to obtain mode shapes at individual orders and corresponding equivalent mass ratios; and
(b) performing random vibration analysis for the phased-array antenna using a modal truncation method to obtain a 3α deformation of the phased-array antenna; and
extracting a 3α deformation of a blind mating clearance of a j-th blind mating connector at an i-th level from the 3α deformation of the phased-array antenna to obtain a deformation of the blind mating clearance of the j-th blind mating connector at the i-th level, wherein the modal truncation method is performed by using modes whose cumulative equivalent mass accounts for more than 90% of a total mass of the phased-array antenna for modal superposition calculation.

In an embodiment, the actual value of each of the electrical performance indicators of the phased-array antenna is calculated by:

$$E = {\sum }_{j = 1}^{m} [ {\prod }_{i = 1}^{n} {S}_{ij} ( Δ {Ge}_{ij} ) ] {I}_{j} {e}^{{∅}_{j}} {f}_{j} exp ( jk \hat{r} \cdot \overline{{r}_{j}} ) ;$$

wherein E represents a radiation pattern of the phased-array antenna, by which actual values of the electrical performance indicators are obtained; ΔGeᵢⱼ represents an electrical clearance of an j-th blind mating connector at a i-th level; Sᵢⱼ(ΔGeᵢⱼ) represents an insertion loss of the j-th blind mating connector at the i-th level when the electrical clearance is ΔGeᵢⱼ; Iⱼe^{φ}^{ⱼ} represents an excitation current applied to an antenna element of the phased-array antenna; fⱼ represents a radiation pattern of the antenna element; k is a wave constant, and k=2π/λ₀; λ₀ is a wavelength; \hat{r} is a unit polarization vector; r̅ⱼ is a position vector of the antenna element; n is the number of blind mating interconnection levels; and m is the number of blind mating connectors at the i-th level.

In an embodiment, the electrical performance indicators comprise a gain, a sidelobe level, and a pointing angle deviation of the phased-array antenna.

In a second aspect, a system for evaluating reliability of blind mating interconnection of a phased-array antenna, comprising:
a first analysis module;
a modeling module;
a second analysis module;
a first reliability evaluation module; and
a second reliability evaluation module;
wherein the first analysis module is configured to perform:
obtaining a mathematical model of the phased-array antenna by using computer aided design (CAD);
extracting a closed dimensional chain between the plurality of blind mating connectors at individual levels and an assembly reference from the mathematical model; and
calculating a blind mating clearance tolerance of each level of the multi-level blind mating interconnection structure based on a dimensional tolerance of the closed dimensional chain;
the modeling module is configured for simplifying a non-load-bearing structure within the mathematical model to establish a finite element model of the phased-array antenna;
the second analysis module is configured to perform steps of:
introducing load conditions to the finite element model; and
performing structural deformation analysis to obtain a blind mating clearance variation of each of the plurality of blind mating connectors;
the first reliability evaluation module is configured to perform steps of:
calculating a sum of blind mating clearance variations of each of the plurality of blind mating connectors and the blind mating clearance tolerance to obtain a blind mating clearance extreme value;
determining whether the blind mating clearance extreme value exceeds a threshold;
if yes, identifying mechanical reliability of the blind mating interconnection of the phased-array antenna as unqualified, and ending an evaluation process, otherwise, proceeding to a process executed by the second reliability evaluation module; and
the second reliability evaluation module is configured to perform steps of:
calculating a total blind mating clearance variation of each of the plurality of blind mating connectors caused by temperature, acceleration load, and random vibration load as an electrical clearance;
calculating an actual value of each of electrical performance indicators of the phased-array antenna based on the electrical clearance and an insertion loss of each of the plurality of blind mating connectors; determining a difference between the actual value and a corresponding ideal value; and
determining whether the difference is less than a threshold of a corresponding electrical performance indicator, if yes, identifying electrical reliability of the phased-array antenna as qualified.

In a third aspect, a computer-readable storage medium, wherein the computer-readable storage medium is configured to store a computer program; and the computer program is configured to be executed by a processor to implement the aforementioned method.

In a fourth aspect, an electronic device, comprising:
a memory;
one or more programs; and
one or more processors;
wherein the one or more programs are stored on the memory; and the one or more processors are configured to execute the one or more programs to implement the aforementioned method.

Compared to the existing technology, the present disclosure has the following beneficial effects.

The method for evaluating the reliability of the blind mating interconnection of the phased-array antenna provided herein comprehensively considers various load factors of the phased-array antenna in a design stage to thoroughly evaluate a mechanical reliability of the blind mating interconnection of the phased-array antenna. Moreover, an electrical reliability of the blind mating interconnection of the phased-array antenna is evaluated from the perspective of the phased-array antenna's electrical performance indicators. The aforementioned method has advantages of convenience, high efficiency and effectiveness to significantly shorten the design iteration cycle of the phased-array antenna and greatly reduce development costs.

### BRIEF DESCRIPTION OF THE DRAWINGS

In order to illustrate the technical solutions in the prior art or in the embodiments of the present disclosure more clearly, the accompanying drawings needed in the description of the prior art or the embodiments of the present disclosure will be briefly described below. Obviously, presented in the accompanying drawings are merely some embodiments of the disclosure, and other drawings can also be obtained by those skilled in the art based on these accompanying drawings without paying creative effort.

FIG. 1 schematically shows a method for evaluating reliability of blind mating interconnection of a phased-array antenna according to an embodiment of the present disclosure;

FIG. 2 schematically shows the method for evaluating reliability of blind mating interconnection of the phased-array antenna according to an embodiment of the present disclosure;

FIG. 3 schematically shows the blind mating interconnection according to an embodiment of the present disclosure; and

FIG. 4 schematically shows the phased-array antenna according to an embodiment of the present disclosure.

### DETAILED DESCRIPTION OF EMBODIMENTS

In order to make the purpose, technical solutions and advantages of the present disclosure clearer, the embodiments of the present disclosure will be clearly and completely described below. Obviously, described below are merely some embodiments of the present disclosure, not all embodiments. Based on the embodiments in the present disclosure, all other embodiments obtained by those of ordinary skill in the art without paying creative labor shall fall within the scope of the present disclosure.

The present disclosure provides a method and a system for evaluating reliability of blind mating interconnection of a phased-array antenna to address the technical problem that the existing methods fail to evaluate the reliability of the blind mating interconnection of the phased-array antenna in a scheme design stage. Moreover, the method not only comprehensively considers various load factors of the phased-array antenna in the design stage, but also thoroughly evaluates the mechanical and electrical reliability of the blind mating interconnection of the phased-array antenna by combining a blind mating clearance tolerance.

To address the above technical problems, the technical solutions in the embodiments of the present disclosure are proposed as follows.

The present disclosure provides a method for evaluating reliability of a blind mating interconnection of a phased-array antenna, which is applied to the aerospace field. This method can analyze a blind mating clearance variation of each level of the multi-level blind mating interconnection structure based on the acceleration overload, vibration, and temperature variation loads during a service period of the phased-array antenna, thereby evaluating its impact on an overall electrical performance of the phased-array antenna. This method not only fast evaluates the blind mating interconnection of the phased-array antenna during the scheme design stage, but also solves the technical problems in the prior art.

In order to better understand the above technical solutions, the above technical solutions will be detailly described below in conjunction with the accompanying drawings and the specific embodiments.

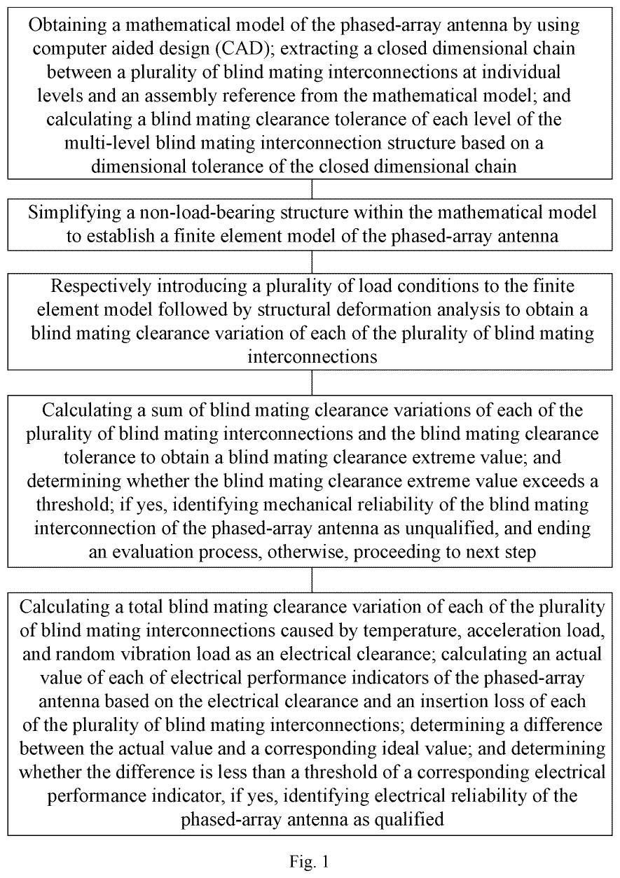

Referring to FIG. 1, the method for evaluating the reliability of the blind mating interconnection of the phased-array antenna provided herein includes the following steps.

(S1) A mathematical model of the phased-array antenna is obtained. A closed dimensional chain is extracted between a plurality of blind mating connectors at individual levels and an assembly reference from the mathematical model. A blind mating clearance tolerance of each level of the multi-level blind mating interconnection structure is calculated based on a dimensional tolerance of the closed dimensional chain.

(S2) Anon-load-bearing structure within the mathematical model is simplified to establish a finite element model of the phased-array antenna.

(S3) A plurality of load conditions are respectively introduced to the finite element model. A structural deformation analysis is performed to obtain a blind mating clearance variation of each of the plurality of blind mating connectors.

(S4) A sum of blind mating clearance variations of each of the plurality of blind mating connectors and the blind mating clearance tolerance is calculated to obtain a blind mating clearance extreme value. The blind mating clearance extreme value is evaluated to determine whether it exceeds a blind mate clearance threshold. If yes, a mechanical reliability of the blind mating interconnection of the phased-array antenna is identified as unqualified, and an evaluation process is ended. Otherwise, step (5) is proceeded.

(S5) A total blind mating clearance variation of each of the plurality of blind mating connectors caused by temperature, acceleration load, and random vibration load is calculated to obtain an electrical clearance of each of the plurality of blind mating connectors. An actual value of each of electrical performance indicators of the phased-array antenna based on the electrical clearance and an insertion loss of each of the plurality of blind mating connectors are calculated. A difference between the actual value and a corresponding ideal value is evaluated to determine whether it is less than a threshold of a corresponding electrical performance indicator. If yes, an electrical reliability of the phased-array antenna is identified as qualified.

The method for evaluating the reliability of the blind mating interconnection of a phased-array antenna provided herein comprehensively considers various load factors of the phased-array antenna during the design stage to thoroughly evaluate the mechanical reliability of the blind mating interconnection. Moreover, the electrical reliability of the blind mating interconnection of the phased-array antenna is evaluated from the perspective of the phased-array antenna's electrical performance indicators. The aforementioned method has advantages of convenience, high efficiency and effectiveness to significantly shorten the design iteration cycle of the phased-array antenna and greatly reduce development costs.

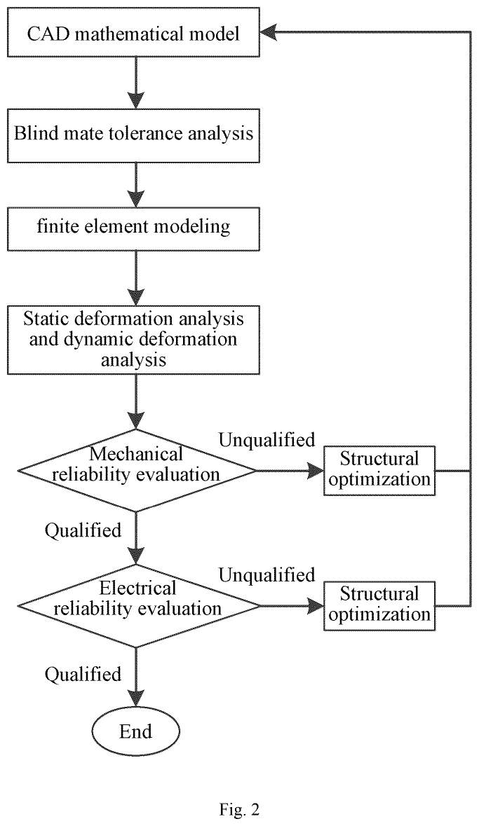

Referring to FIG. 2, the steps proposed herein are detailly described.

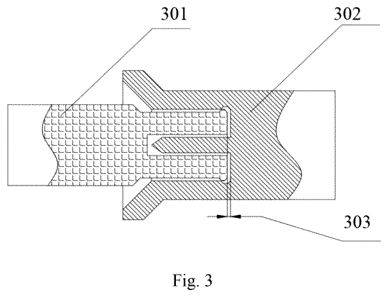

Referring to an embodiment in FIG. 3, the blind mating interconnection includes a male connector 301, a female connector 302 and a blind mating clearance 303. The blind mating clearance 303 is arranged between the male connector 301 and the female connector 302.

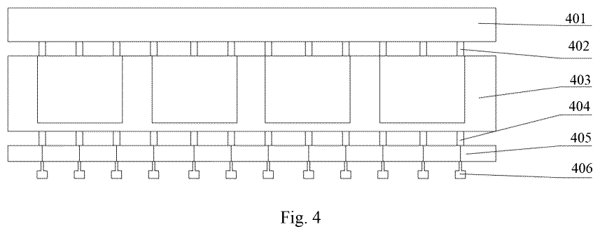

Referring to an embodiment in FIG. 4, the phased-array antenna includes a power distribution network 401, a first-level blind mating 402, a transceiver component 403, a second-level blind mating 404, an antenna array 405 and antenna elements 406. A surface of the phased-array antenna is configured as a rectangular shape, and is provided with 12×20 antenna units distributed in a rectangular array. Aback side of the phased-array antenna is provided with 20 12-channel transceiver components 403. A front-end transceiver channel of the transceiver component 403 is connected and powered with the antenna units in a one-to-one manner through the blind mating interconnection, where the number of the blind mating interconnections is 12×20. A transceiver channel of the power distribution network is connected and powered with a rear-end transceiver channel of the transceiver component 403 in a one-to-one manner through the blind mating interconnection, where the number of the blind mating interconnections is 12×20. The transceiver component 403 and the power distribution network 401 are respectively fixed to the surface of the phased-array antenna via bolts, where the bolts are respectively provided at two ends of the transceiver component 403 and two ends of the power distribution network 401.

In an embodiment, step (S1) is performed through the following steps.

The mathematical model of the phased-array antenna is established by using Pro/Engineer (ProE) software. The closed dimensional chain between the plurality of blind mating connectors at individual levels and the assembly reference from the mathematical model. The blind mating clearance tolerance of each level of the multi-level blind mating interconnection structure based on the dimensional tolerance of the closed dimensional chain is calculated. The dimensional tolerance of the closed dimensional chain includes a part dimensional tolerance and an assembly dimensional tolerance.

In this embodiment, the extreme tolerance is selected as the blind mating clearance tolerance, satisfying the following formula:

$$Δ {G}_{di} = {\sum }_{k = 1}^{K} \vert {ξ}_{ik} \vert {T}_{ik} ;$$

where Tᵢₖ is a k-th dimensional tolerance of the blind mating connector at an i-th level; ξᵢₖ is a transfer coefficient; the dimensional tolerance follows a normal distribution; and K represents a total number of the dimensional tolerance of the closed dimensional chain at the current level.

In an embodiment, the dimensional tolerance of the closed dimensional chain at a second level is described as follows.

Antenna array connector mounting hole dimensional tolerance: 0.02.

Assembly tolerance between the female connector and the antenna array: 0.01.

Transceiver component connector mounting hole dimensional tolerance: 0.02

Assembly tolerance between the male connector and the transceiver component: 0.01.

Assembly tolerance between the transceiver component and the antenna array: 0.02.

The dimensional tolerances of the closed dimensional chain follow a normal distribution, such that the extreme tolerance of the blind mating clearance tolerance of the blind mating interconnection at the second level is calculated as:

$$Δ {G}_{d 2} = {\sum }_{k = 1}^{K} \vert {ξ}_{k} \vert {T}_{k} = 1 * 0.02 + 1 * 0.01 + 1 * 0.02 + 1 * 0.01 + 1 * 0.02 = 0.08 ;$$

where the transfer coefficient ξₖ is taken as a value based on actual conditions (e.g., when a direction is opposite, ξₖ=−1).

In an embodiment, the dimensional tolerance of the closed dimensional chain at a first level is described as follows.

Antenna array connector mounting hole dimensional tolerance: 0.01

Assembly tolerance between the female connector and the antenna array: 0.01.

Transceiver component connector mounting hole dimensional tolerance: 0.02.

Assembly tolerance between the male connector and the transceiver component: 0.01.

Assembly tolerance between the transceiver component and the antenna array: 0.01.

The dimensional tolerances of the closed dimensional chain follow a normal distribution, such that the extreme tolerance of the blind mating clearance tolerance of the blind mating interconnection at the first level is calculated as:

$$Δ {G}_{d 1} = {\sum }_{k = 1}^{K} \vert {ξ}_{k} \vert {T}_{k} = 1 * 0.01 + 1 * 0.01 + 1 * 0.02 + 1 * 0.01 + 1 * 0.01 = 0.06 .$$

In an embodiment, step (S2) of simplifying a non-load-bearing structure within the mathematical model to establish a finite element model of the phased-array antenna is performed through the following steps.

Based on the mathematical model of the phased-array antenna, non-load-bearing structures such as cables, bolts, and pipes are simplified. The finite element model of the phased-array antenna is established by utilizing finite element analysis software. The finite element model of the phased-array antenna includes the definitions of mesh, materials, and boundary conditions. The definition of the materials includes properties such as density, Poisson's ratio, and a coefficient of thermal expansion. The definition of the boundary conditions is determined based on mounting and fixing methods during a service period of the phased-array antenna. The finite element analysis software is selected from the group consisting of Hypermesh, Abaqus and Ansys.

In an embodiment, step (S3) is performed through the following steps.

The plurality of load conditions include static analysis loads and dynamic analysis loads.

The static analysis loads include an assembly stress generated during an assembly process of the phased-array antenna, a temperature during a service process of the phased-array antenna, and an acceleration load endured during the service process. The assembly stress refers to a structurally-internal stress caused by an insertion force of the blind mating plug during the assembly process. The blind mating plug includes quick connectors, such as a RF connector (radio-frequency connector), a low-frequency connector, and a liquid-cooling connector. The loads of temperature and acceleration overload are determined based on a mission profile during the service period of the phased-array antenna. Specifically, the temperature load referred to is a maximum temperature difference that the phased-array antenna can withstand relative to room temperature during the service period of the phased-array antenna, and the acceleration overload load referred to is a maximum acceleration overload that the blind mating interconnection of an axial phased-array antenna can withstand during the service period of the phased-array antenna.

Dynamic analysis load is a random vibration load that the phased-array antenna can withstand during the service period of the phased-array antenna. It can be expressed in a form of a power density spectrum, and can follow a normal distribution.

The static analysis loads are introduced to the finite element model of the phased-array antenna, and a static structural deformation analysis is performed to obtain the blind mating clearance variation of each of the plurality of blind mating connectors. In other words, the variations of the blind mating clearance of a j-th blind mating connector at an i-th level under the loads of assembly stress, temperature, and acceleration overload are represented as ΔGpᵢⱼ, ΔGtᵢⱼ, ΔGaᵢⱼ, respectively.

The dynamic analysis loads are introduced to the finite element model, and a dynamic structural deformation analysis is performed to obtain the blind mating clearance variation of the plurality of blind mating connectors. The dynamic structural deformation analysis is performed through steps of.
(a) A modal analysis of the phased-array antenna is performed to obtain various mode shapes and the corresponding equivalent mass ratios.
(b) A random vibration analysis of the phased-array antenna is performed by using a modal truncation method (i.e., a first n modes whose equivalent mass sum accounts for more than 90% of a total mass of the structure are taken for modal superposition calculation.) to obtain a 3σ deformation of the phased-array antenna (with a probability of 99.73%). A 3σ deformation of a blind mating clearance of a j-th blind mating connector at an i-th level ΔGrᵢⱼ, is extracted from the 3σ deformation of the phased-array antenna to obtain a blind mating clearance variation of the j-th blind mating connector at the i-th level (with a probability of 99.73%).

In some embodiments, step (S4) is performed through the following steps.

(S401) A sum of blind mating clearance variations under the loads of the assembly stress, temperature and acceleration overload of each of the plurality of blind mating connectors and the blind mating clearance tolerance is calculated to obtain a blind mating clearance extreme value, satisfying the following formula:

$$Δ {Gm}_{ij} = Δ {Gd}_{i} + Δ {Gp}_{ij} + Δ {Gt}_{ij} + Δ {Ga}_{ij} + Δ {Gr}_{ij} .$$

(S402) The blind mating clearance extreme value is evaluated to determine whether it is less than a corresponding blind mating clearance threshold. If yes, step (S5) is proceeded. Otherwise, the mechanical reliability of the blind mating interconnection of the phased-array antenna is identified as unqualified, and the blind mating interconnection of the phased-array antenna is optimized, thereby returning to step (S1).

In some embodiments, each of the blind mating clearance thresholds of the blind mating interconnections at the same level is configured to be the same as each other. Each of the blind mating clearance thresholds of the blind mating interconnections at the different level is configured to be the same as or different from each other. Each of the blind mating clearance thresholds of the blind mating interconnections is configured as a maximum allowable blind mating clearance of the blind mating interconnection.

In an embodiment, if an extreme value of the blind mating clearance of the 225th blind mating interconnection at a second level is 2.31 mm (i.e., ΔGm_{2.225}=2.31 mm) exceeding the maximum allowable blind mating clearance of 2 mm, the 225th blind mating interconnection at the second level is identified as a disengagement failure, and the mechanical reliability of the phased-array antenna of the blind mating interconnection is identified as unqualified. Thus, the blind mating interconnection of the phased-array antenna is optimized through methods of thickening the antenna unit mounting plate or adding reinforcing ribs to the surface of the antenna unit mounting plate. After optimizing, the above steps (S1)-(S4) are repeated. If calculation results show that each of the blind mating clearances ΔGmᵢⱼ of the blind mating interconnections is less than the maximum allowable blind mating clearance, the mechanical reliability of the blind mating interconnection is identified as qualified.

In an embodiment, step (S5) is performed through the following steps.

(S501) A total blind mating clearance variation of each of the plurality of blind mating connectors caused by temperature, acceleration load, and random vibration load is calculated to obtain an electrical clearance. An actual value of each of electrical performance indicators of the phased-array antenna is calculated based on the electrical clearance and an insertion loss of each of the plurality of blind mating connectors.

The electrical performance indicators include a gain of the phased-array antenna, a sidelobe level, and a pointing angle deviation.

Based on an electrical clearance ΔGeᵢⱼ of the blind mating interconnection, a corresponding insertion loss S of the blind mating interconnection is analyzed through experiments, taking into account an insertion loss Sgᵢⱼ when there is a clearance in the blind mating interconnection and an insertion loss Soᵢⱼ when there is no clearance in an ideal blind mating interconnection.

An electrical performance indicator of the phased-array antenna is calculated, satisfying the following formula:

$$E = {\sum }_{j = 1}^{m} [ {\prod }_{i = 1}^{n} {S}_{ij} ( Δ {Ge}_{ij} ) ] {I}_{j} {e}^{{∅}_{j}} {f}_{j} exp ( jk \hat{r} \cdot \overline{{r}_{j}} ) ;$$

where E represents a radiation pattern of the to-be-tested phased-array antenna; the radiation pattern of the to-be-tested phased-array antenna is configured to obtain the actual electrical performance indicators; Sᵢⱼ(ΔGeᵢⱼ) represents an insertion loss of the j-th blind mating interconnection at the i-th level when the electrical clearance is ΔGeᵢⱼ and is Sgᵢⱼ; Iⱼe^{φ}^{ⱼ} represents an excitation current applied to an antenna element of the to-be-tested phased-array antenna; fⱼ represents a radiation pattern of the antenna element; k=2π/λ₀ is a wave constant; λ₀ is a wavelength; \hat{r} is an unit polarization vector; r̅ⱼ is a position vector of the antenna element; n is the number of the levels, and m represents the number of blind mating interconnections at the i-th level.

(S502) A difference between an actual value of the electrical performance indicator and a corresponding ideal value of the electrical performance indicator is calculated, thereby determining whether it is less than a threshold of a corresponding electrical performance indicator. If yes, the electrical reliability of the blind mating interconnection of the phased-array antenna is identified as qualified. Otherwise, the electrical reliability is identified as unqualified, and the blind mating interconnection of the phased-array antenna is optimized, thereby returning to the step (S1).

For the ideal case where there is no clearance in the blind mating interconnection, the overall electrical performance indicators of the phased-array antenna are calculated using the following formula:

$$E = {\sum }_{j = 1}^{m} [ {\prod }_{i = 1}^{n} {So}_{ij} ] {I}_{j} {e}^{{∅}_{j}} {f}_{j} exp ( jk \hat{r} \cdot \overline{{r}_{j}} ) ;$$

The phased-array antenna's electrical performances when a clearance exists in the blind mating interconnection are compared to those when the blind mating interconnection is ideal (i.e., with no clearance). When a clearance exists, the phased-array antenna exhibits a pointing angle deviation of 0.32°, a gain loss of 2.5 dB, and a sidelobe level rise of 3.2 dB. Considering that the design requirements specify that the threshold for pointing angle deviation is 0.2° (i.e., the pointing angle deviation must be less than 0.2°), the threshold for gain loss is 2 dB (i.e., gain loss must be less than 2 dB), and the threshold for sidelobe level rise is 2.5 dB (i.e., the sidelobe level rise must be less than 2.5 dB), it is evident that the variations in the electrical performance indicators do not meet the design requirements. Therefore, the electrical reliability evaluation of the blind mating interconnection fails, and the phased-array antenna structure needs to be optimized.

After the optimized design is implemented, repeat steps S1-S5 to recalculate the electrical performance of the phased-array antenna. If the results show a pointing angle deviation of 0.14°, a gain loss of 1.4 dB, and a sidelobe level rise of 2.1 dB, which meet the design requirements, then the electrical reliability evaluation of the blind mating interconnection is qualified.

A system for evaluating reliability of blind mating interconnection in a phased-array antenna provided herein includes a first analysis module, a modeling module, a second analysis module, a first reliability evaluation module and a second reliability evaluation module.

The first analysis module is configured to perform the following steps.

A mathematical model of the phased-array antenna is obtained by using computer aided design (CAD).

A closed dimensional chain between the plurality of blind mating connectors at individual levels and an assembly reference is extracted from the mathematical model.

A blind mating clearance tolerance of each level of the multi-level blind mating interconnection structure is calculated based on a dimensional tolerance of the closed dimensional chain.

The modeling module is configured for simplifying a non-load-bearing structure within the mathematical model to establish a finite element model of the phased-array antenna.

The second analysis module is configured to perform steps of introducing load conditions to the finite element model, and performing structural deformation analysis to obtain a blind mating clearance variation of each of the plurality of blind mating interconnections.

The first reliability evaluation module is configured to perform the following steps.

A sum of blind mating clearance variations of each of the plurality of blind mating connectors and the blind mating clearance tolerance is calculated to obtain a blind mating clearance extreme value, thereby determining whether the blind mating clearance extreme value exceeds a threshold.

If yes, the mechanical reliability of the blind mating interconnection of the phased-array antenna is identified as unqualified, and an evaluation process is ended. Otherwise, a process executed by the second reliability evaluation module is proceeded.

The second reliability evaluation module is configured to perform the following steps.

A total blind mating clearance variation of each of the plurality of blind mating connectors caused by temperature, acceleration load, and random vibration load as an electrical clearance is calculated.

An actual value of each of electrical performance indicators of the phased-array antenna is calculated based on the electrical clearance and an insertion loss of each of the plurality of blind mating connectors.

A difference between the actual value and a corresponding ideal value is evaluated, thereby determining whether the difference is less than a threshold of a corresponding electrical performance indicator.

If yes, the electrical reliability of the phased-array antenna is identified as qualified.

It should be understood that, the system for evaluating reliability of the blind mating interconnection of phased-array antennas provided in the embodiments of the present disclosure corresponds to the aforementioned method for evaluating the reliability of blind mating interconnection of the phased-array antenna. The explanations, examples, and beneficial effects of the relevant contents can be referred to the corresponding contents in the aforementioned method, and will not be repeated herein.

A computer-readable storage medium is configured to store a computer program; and the computer program is configured to be executed by a processor to implement the aforementioned method.

An electronic device includes a memory, one or more programs and one or more processors. The memory is configured to store the one or more programs. The one or more processors are configured to execute the one or more programs to implement the aforementioned method.

Compared to the existing technology, the present disclosure has the following beneficial effects.

The method for evaluating the reliability of the blind mating interconnection of the phased-array antenna provided herein comprehensively considers various load factors of the phased-array antenna in a design stage to thoroughly evaluate a mechanical reliability of the blind mating interconnection of the phased-array antenna. Moreover, an electrical reliability of the blind mating interconnection of the phased-array antenna is evaluated from the perspective of the phased-array antenna's electrical performance indicators. The aforementioned method has advantages of convenience, high efficiency and effectiveness to significantly shorten the design iteration cycle of the phased-array antenna and greatly reduce development costs.

It should be noted that the relation terms herein such as “first”, “second” are used to distinguish one entity or operation from another, and do not necessarily require or imply any actual relationship or sequence between these entities or operations. Moreover, the terms “comprise,” “include,” or any other variants thereof are intended to cover non-exclusive inclusion, so that a process, method, article, or apparatus comprising a series of elements not only includes those elements but also includes other elements not explicitly listed, or elements inherent to such process, method, article, or apparatus. In the absence of further limitations, an element defined by the phrase “comprising a . . . ” does not exclude the presence of additional identical elements in the process, method, article, or apparatus that includes the specified element.

The above embodiments are merely illustrative of the technical solutions of the disclosure, but are not intended to limit the present disclosure. Although this disclosure has been described in detail with reference to the above embodiments, any modification and equivalent replacement can be made within the spirit and principle of the present disclosure, and shall fall within the scope of the disclosure defined by the appended claims.

What is claimed is:

1. A method for evaluating reliability of blind mating interconnection of a phased-array antenna, the phased-array antenna comprising a multi-level blind mating interconnection structure, each level comprising a plurality of blind mating connectors, and the method comprising:
(1) obtaining a mathematical model of the phased-array antenna by using computer aided design (CAD); extracting a closed dimensional chain between the plurality of blind mating connectors at individual levels and an assembly reference from the mathematical model; and calculating a blind mating clearance tolerance of each level of the multi-level blind mating interconnection structure based on a dimensional tolerance of the closed dimensional chain;
(2) simplifying a non-load-bearing structure within the mathematical model to establish a finite element model of the phased-array antenna;
(3) respectively introducing a plurality of load conditions to the finite element model followed by structural deformation analysis to obtain a blind mating clearance variation of each of the plurality of blind mating connectors;
(4) calculating a sum of blind mating clearance variations of each of the plurality of blind mating connectors and the blind mating clearance tolerance to obtain a blind mating clearance extreme value; and
determining whether the blind mating clearance extreme value exceeds a threshold;
if yes, identifying mechanical reliability of the blind mating interconnection of the phased-array antenna as unqualified, and ending an evaluation process, otherwise, proceeding to step (5); and
(5) calculating a total blind mating clearance variation of each of the plurality of blind mating connectors caused by temperature, acceleration load, and random vibration load as an electrical clearance; calculating an actual value of each of electrical performance indicators of the phased-array antenna based on the electrical clearance and an insertion loss of each of the plurality of blind mating connectors; determining a difference between the actual value and a corresponding ideal value; and determining whether the difference is less than a threshold of a corresponding electrical performance indicator, if yes, identifying electrical reliability of the phased-array antenna as qualified.

2. The method of claim 1, wherein the tolerance comprises a worst-case tolerance.

3. The method of claim 1, wherein the dimensional tolerance of the closed dimensional chain comprises a part dimensional tolerance and an assembly dimensional tolerance.

4. The method of claim 1, wherein the plurality of load conditions comprise static analysis loads and dynamic analysis loads;
the static analysis loads comprise an assembly stress generated during an assembly process of the phased-array antenna, a temperature during a service process of the phased-array antenna, and an acceleration load endured during the service process; and
the dynamic analysis loads comprise a random vibration load during the service process, wherein the random vibration load is represented by a power spectral density, and follows a normal distribution.

5. The method of claim 4, wherein the step of respectively introducing a plurality of load conditions to the finite element model followed by structural deformation analysis to obtain a blind mating clearance variation of each of the plurality of blind mating connectors comprises:
introducing the static analysis loads to the finite element model followed by static structural deformation analysis to obtain the blind mating clearance variation of each of the plurality of blind mating connectors; and
introducing the dynamic analysis loads to the finite element model followed by dynamic structural deformation analysis to obtain the blind mating clearance variation of each of the plurality of blind mating connectors, wherein the dynamic structural deformation analysis is performed through steps of:
(a) performing modal analysis for the phased-array antenna to obtain mode shapes at individual orders and corresponding equivalent mass ratios; and
(b) performing random vibration analysis for the phased-array antenna using a modal truncation method to obtain a 3σ deformation of the phased-array antenna; and
extracting a 3σ deformation of a blind mating clearance of a j-th blind mating connector at an i-th level from the 3σ deformation of the phased-array antenna to obtain a blind mating clearance variation of the j-th blind mating connector at the i-th level, wherein the modal truncation method is performed by using modes whose cumulative equivalent mass accounts for more than 90% of a total mass of the phased-array antenna for modal superposition calculation.

6. The method of claim 1, wherein the actual value of each of the electrical performance indicators of the phased-array antenna is calculated by:
$$E = {\sum }_{j = 1}^{m} [ {\prod }_{i = 1}^{n} {S}_{ij} ( Δ {Ge}_{ij} ) ] {I}_{j} {e}^{{∅}_{j}} {f}_{j} exp ( jk \hat{r} \cdot \overline{{r}_{j}} ) ;$$
wherein E represents a radiation pattern of the phased-array antenna, by which actual values of the electrical performance indicators are obtained; ΔGeᵢⱼ represents an electrical clearance of an j-th blind mating connector at a i-th level; Sᵢⱼ(ΔGeᵢⱼ) represents an insertion loss of the j-th blind mating connector at the i-th level when the electrical clearance is ΔGeᵢⱼ; Iⱼe^{φ}^{ⱼ} represents an excitation current applied to an antenna element of the phased-array antenna; fⱼ represents a radiation pattern of the antenna element; k is a wave constant, and k=2π/λ₀; λ₀ is wavelength; \hat{r} is a unit polarization vector; r̅ⱼ is a position vector of the antenna element; n is the number of blind mating interconnection levels; and m is the number of blind mating connectors at the i-th level.

7. The method of claim 6, wherein the electrical performance indicators comprise a gain, a sidelobe level, and a pointing angle deviation of the phased-array antenna.

8. A system for evaluating reliability of blind mating interconnection of a phased-array antenna, comprising:
a first analysis module;
a modeling module;
a second analysis module;
a first reliability evaluation module; and
a second reliability evaluation module;
wherein the first analysis module is configured to perform:
obtaining a mathematical model of the phased-array antenna by using computer aided design (CAD);
extracting a closed dimensional chain between the plurality of blind mating connectors at individual levels and an assembly reference from the mathematical model; and
calculating a blind mating clearance tolerance of each level of the multi-level blind mating interconnection structure based on a dimensional tolerance of the closed dimensional chain;
the modeling module is configured for simplifying a non-load-bearing structure within the mathematical model to establish a finite element model of the phased-array antenna;
the second analysis module is configured to perform steps of:
introducing load conditions to the finite element model; and
performing structural deformation analysis to obtain a blind mate clearance variation of each of the plurality of blind mate connectors;
the first reliability evaluation module is configured to perform steps of:
calculating a sum of blind mating clearance variations of each of the plurality of blind mating connectors and the blind mating clearance tolerance to obtain a blind mating clearance extreme value; and
determining whether the blind mating clearance extreme value exceeds a threshold;
if yes, identifying mechanical reliability of the blind mating interconnection of the phased-array antenna as unqualified, and ending an evaluation process, otherwise, proceeding to a process executed by the second reliability evaluation module; and
the second reliability evaluation module is configured to perform steps of:
calculating a total blind mating clearance variation of each of the plurality of blind mating connectors caused by temperature, acceleration load, and random vibration load as an electrical clearance;
calculating an actual value of each of electrical performance indicators of the phased-array antenna based on the electrical clearance and an insertion loss of each of the plurality of blind mating connectors; determining a difference between the actual value and a corresponding ideal value; and
determining whether the difference is less than a threshold of a corresponding electrical performance indicator, if yes, identifying electrical reliability of the phased-array antenna as qualified.

9. A computer-readable storage medium, wherein the computer-readable storage medium is configured to store a computer program; and the computer program is configured to be executed by a processor to implement the method of claim 1.

10. An electronic device, comprising:
a memory;
one or more programs; and
one or more processors;
wherein the one or more programs are stored on the memory; and the one or more processors are configured to execute the one or more programs to implement the method of claim 1.
